(19) United States
(12) Patent Application Publication
(10) Pub. No.: US 2006/0120442 A1
(43) Pub. Date: Jun. 8, 2006

(54) System and method to determine loop characteristics

(76) Inventors: Peter James Melsa, Niles, MI (US); Thomas Nicholas Zogakis, Plano, TX (US); Wade Alan Bastien, San Jose, CA (US); Madhusudan Hegde, Union City, CA (US); Benjamin Aaron Wiseman, Mt. View, CA (US)

Correspondence Address: TEXAS INSTRUMENTS INCORPORATED, P O BOX 655474, M/S 3999, DALLAS, TX, 75265, US

(21) Appl. No.: 11/007,032

(22) Filed: Dec. 8, 2004

(51) Int. Cl. H04L 5/16

(52) U.S. Cl. 375/222

(57) ABSTRACT

Systems and methods are disclosed for determining characteristics of a communications medium, such as a subscriber loop. In one embodiment, a system is disclosed to determine at least one characteristic associated with a subscriber loop. The system includes memory that stores data indicative of signal responses and loop characteristics for a plurality of loop configurations. A processor is programmed to ascertain at least one loop characteristic associated with the subscriber loop based on evaluation of data associated with a signal response received via the subscriber loop relative to at least a portion of the data indicative of signal responses stored in the memory.

### TECHNICAL FIELD

This invention relates generally to telecommunications, and more specifically relates to a system and method to determine loop characteristics.

### BACKGROUND

Research and development in telecommunications applications have been expanding to meet the increasing popularity in the Internet. One particular application relates to digital subscriber line (DSL) technologies, including symmetric DSL (SDSL) and asymmetric DSL (ADSL) and high data rate DSL (HDSL), to name a few. DSL can employ a variety of possible information rates and protocols depending on the type of DSL being implemented. DSL is a modem technology that converts existing telephone lines into access paths for multimedia and high speed data communications. DSL utilizes advanced digital signal processing and creative algorithms to provide greater amounts of information through twisted-pair telephone lines than was conventionally feasible. Accordingly, a person can employ DSL modems to communicate with a local Internet Service Provider (ISP), and the person still can be able to talk on the phone. For example, in an ADSL loop, a central office line driver drives the DSL signal onto telephone lines. The ADSL signal includes data streams that are carried over tones that are amplitude, phase modulated and frequency separated by about 4 KHz.

Conventional DSL modem designs include circuitry referred to as analog front ends in which operations, such as digital-to-analog and analog-to-digital conversion, amplification/attenuation and filtering, are performed. The analog front ends transmit and receive data to and from associated telephone lines (subscriber loops). During normal operation when a modem exists at both ends, the configuration and characteristics of the loop are generally known. Service providers also maintain records of subscriber loops, such as defining their length, configuration, and location. However, field staff may change the subscriber loop configuration and not fully update these records. Also, loop characteristics can change, such as when malfunctions occur somewhere in the loop. Accordingly, there is an impetus in the industry to make loop qualification or testing a more routine practice by DSL service providers.

One approach to perform qualification is to employ separate dedicated measurement hardware, which can be expensive and, therefore, unattractive. Another more attractive approach is to design DSL chips to monitor and provide performance parameters to the management system. The performance data could be read periodically (perhaps once a month) for all deployed lines from which a database of real measurements could be constructed. Then when a potential new customer requests DSL service, the operator could more easily decide whether that request could be granted. Qualification and testing can also be performed to determine information about physical properties or operation of the line.

### SUMMARY

The present invention relates generally a system and method to determine loop characteristics. One aspect of the present invention provides a system to determine at least one characteristic associated with a subscriber loop. The system includes memory that stores data indicative of signal responses and loop characteristics for a plurality of loop configurations. A processor is programmed to ascertain at least one loop characteristic associated with the subscriber loop based on evaluation of data associated with a signal response received via the subscriber loop relative to at least a portion of the data indicative of signal responses stored in the memory.

Still another aspect of the present invention provides a system to determine at least one characteristic of a communications medium. The system may include a measurement component that determines an indication of a response received from the communications medium in response to a test signal transmitted over the communications medium. A data structure (e.g., stored in memory) includes signal response data for a signal response associated with each of a plurality of known configurations of the communications medium. The data structure includes data indicative of at least one characteristic associated with each of the plurality of known configurations of the communications medium. An evaluator evaluates the indication of the response received from the communications medium relative to the signal response data of the data structure to determine the at least one characteristic of the communications medium. The communications medium can be subscriber loop of a DSL system, with the characteristics including, but not limited to one or more of loop length, gauge, and termination type of the communications medium.

Yet another aspect of the present invention provides a system to determine at least one characteristic associated with a subscriber loop. The system includes means for providing an indication of a signal response during a test mode in response to a test signal transmitted over the subscriber loop. The system also includes means for identifying the at least one loop characteristic based on comparing the indication of the signal response relative to a plurality of expected responses associated with known loop configurations.

Still another aspect of the present invention provides a method that includes transmitting at least one test signal over a subscriber loop and receiving a signal response to the at least one test signal. An actual response associated with the subscriber loop is determined based on the received signal response. The actual response is compared relative to stored response data for at least one expected response for at least one predetermined loop configuration, and at least one characteristic of the subscriber loop it identified based on the comparison.

### BRIEF DESCRIPTION OF THE DRAWINGS

FIG. 1 depicts an example of a communication system employing loop testing according to an aspect of the present invention.

FIG. 2 depicts an example of a modem system operative to determine loop characteristics according to an aspect of the present invention.

FIG. 3 depicts an example of a system that can be utilized to determine loop characteristics according to an aspect of the present invention.

FIG. 4 is a graph depicting a comparison of actual loop characteristics relative to loop characteristics determined according to an aspect of the present invention.

FIG. 5 depicts an example of a system that can be utilized to generate a loop table for use in a system according to an aspect of the present invention.

FIG. 6 depicts a graph for a frequency response for a given loop configuration that can be utilized for programming a loop table according to an aspect of the present invention.

FIG. 7 depicts another graph for a frequency response for a given loop configuration that can be utilized for programming a loop table according to an aspect of the present invention.

FIG. 8 depicts an example of a modem system that can implement loop testing with calibration according to an aspect of the present invention.

FIG. 9 is a graph depicting a comparison of actual loop characteristics relative to loop characteristics employing calibration determined according to an aspect of the present invention.

FIG. 10 is a flow diagram depicting a method that may be utilized to generate a loop table according to an aspect of the present invention.

FIG. 11 is a flow diagram depicting a method that can be utilized to determine loop characteristics according to an aspect of the present invention.

### DETAILED DESCRIPTION

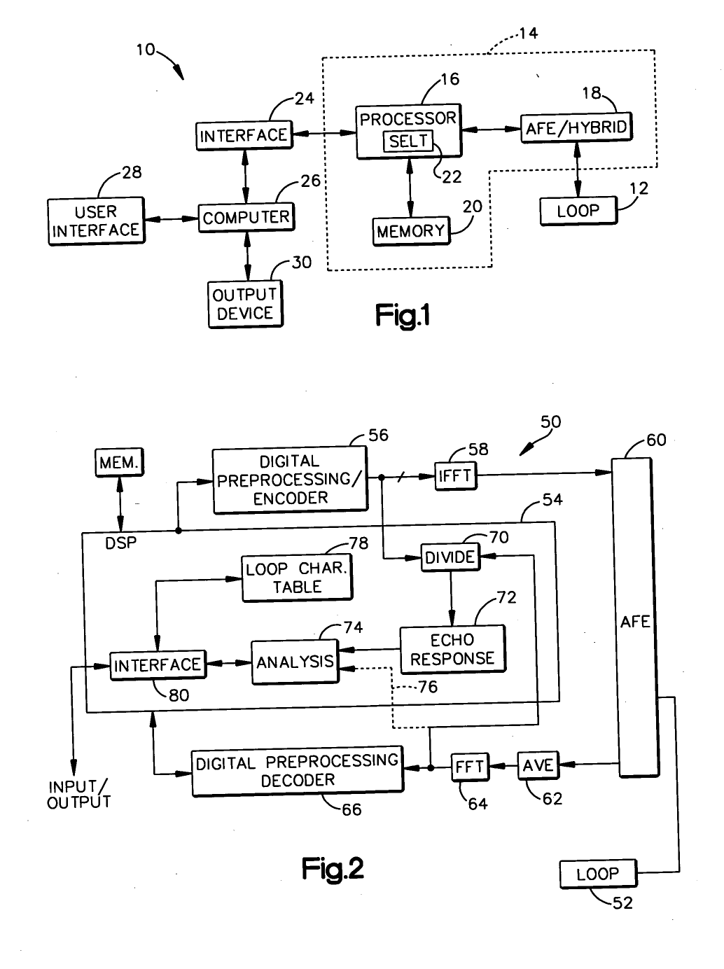

FIG. 1 depicts an example of a system 10 that can be utilized to ascertain one or more characteristics associated with a loop 12, such as a subscriber loop in a digital subscriber link (DSL) or asymmetric DSL (ADSL) system. The characteristics of the loop 12 can include, but are not limited to, the gauge of the line utilized to form the loop, loop length, termination type (e.g., impedance) of the loop, multiple segments of different gauges, as well as one or more bridge taps. The particular characteristics can be tailored to a specific standard, such as those utilized in the U.S. and in Europe. The loop 12, for example can be implemented as a plain old telephone service (POTS) twisted pair line of an electrically conductive material (e.g., copper), although other types of communication media can be utilized for which it may be desirable to ascertain characteristics of the loop. For purposes of consistency in the following description, the communications medium is assumed to be a loop in a POTS environment, such as may be implemented in an ADSL circuit.

The system 10 can be implemented within a modem 14 that includes a processor (e.g., a digital signal processor (DSP)) that is operative to control associated circuitry for communicating signals through an analog front end (AFE)/hybrid system 18. Those skilled in the art will understand and appreciate various types of modulation schemes and encoders that can be utilized to transmit data (e.g., including voice data, information data, video data or a combination of voice, video, and information data) through the AFE/hybrid 18 and over the loop 12. The modem 14 can be located at a central office, a remote terminal site, or, alternatively, it can be located at a consumer premises.

The processor 16 implements a single ended loop testing (SELT) algorithm 22 that controls a process to determine characteristics or parameters associated with the loop 12. SELT is an automated way of testing a DSL loop from one end of the line, either from the central office (CO), the remote terminal (RT) or from the subscriber's end. Unlike dual-ended loop testing (DELT), where someone, usually the operator's technician, must install a DSL modem or some sort of test device at the consumer's end of the line, SELT does not require a technician or any equipment at both ends. Accordingly, SELT can be performed from the network side without physically accessing the subscriber site.

The processors 16 can be utilized in conjunction with a plurality of modems (e.g., operating a multi-port modem), AFE/hybrids and associated communications circuitry for ascertaining loop characteristics for any number of one or more loops 12. For purposes of brevity and not by way of limitation, the modem 14 is described as a single port modem that communicates over a single loop 12.

The modem 14 can include memory 20 programmed with data indicative of responses for one or more loop configurations and with data that describes one or more characteristics or parameters associated with each of the loop configurations. For example, the data can be stored as a table, although other forms of data structures can be employed for storing the data. The characteristics of the subscriber loops for which the response data is stored in the memory 20 are known so that the processor 16 can employ the SELT algorithm 22 relative to the data in the memory to determine one or more loop characteristics for the loop 12 based on the data in the memory 20. As parts of a testing process, the processor 16 causes a signal to be transmitted-through the AFE/hybrid 18 over the loop 12. For example, the signal can be transmitted on a set of frequency bands (or tones) that exist in both the frequency bands employed in transmitter and receiver portions of the modem. As used herein, a “tone” corresponds to the frequency inputs to an inverse fast Fourier transform that defines the tone, defining a separate frequency band in the time domain. For instance, in ADSL, data can be communicated over a loop according to a frequency division multiplexing scheme that employs a plurality of tones. A response to the signal transmission is received by the modem 14 and is communicated to the processor 16 after employing some pre-processing, including conversion through the AFE/hybrid 18.

The SELT algorithm 22 is programmed to ascertain the one or more loop characteristics associated with the loop 12 based on the signal response data relative to at least some of the data stored in the memory 20. As mentioned above the data stored in the memory 20 includes response data for known loop configurations based on which the processor 16 can determine one or more characteristics of the loop 12. The type of response data stored in the memory 20 corresponds to the same type of responses being measured and analyzed by the SELT algorithm 22. For example, the response data in the memory 20 can correspond to a signal response or echo response and can be in the time domain, frequency domain or a combination of time domain and frequency domain.

To reduce overhead requirements for implementing the SELT algorithm 22, response data for different loops can be stored for each loop as a set of coefficients selected to represent at least a portion of the responses for a plurality of loop configurations having known loop characteristics. The loop characteristics for each loop can also be stored in the memory 20 associated with a respective set of coefficients for a given loop configuration. By storing coefficients associated with the responses for different loop configurations in the memory 20, memory requirements for implementing the table in the memory 20 can be significantly reduced. When coefficients are stored in the memory to represent responses for different loop configurations, the processor 16 can be programmed to convert coefficients for a given response for different loop configurations to a corresponding portion of a response that can be compared relative to corresponding portions of the response for the received signal. Alternatively, the processor 16 can be programmed to convert the response for a given received signal response to a set of corresponding coefficients that can be evaluated relative to the stored coefficients to determine corresponding characteristics of the loop 12 that is being evaluated.

As an example, the processor 16 can implement the SELT algorithm 22 to perform the comparison between the received signal response and the response data stored in the memory 20. For instance, circuitry in the modem 14 can convert the received signal response to an echo frequency response by dividing out the transmitted test signal in the frequency domain. The processor 16 can employ the SELT algorithm 22 to convert the stored coefficients to corresponding echo frequency response data and compare the echo frequency response relative to the corresponding echo frequency response data for at least some of the loop configurations. The stored response data that produces a minimum error (e.g., mean square error as well as other statistical or non-statistical methods) between the received echo frequency response and the converted echo frequency response data can be employed to identify loop characteristics for the loop as matching those associated with the stored response. Those skilled in the art will understand and appreciate that other types of signal responses, including both echo and transmitted portions of the received signal can be utilized to ascertain loop characteristics. Additionally, the evaluation and analysis of the received signal can be performed on a time domain or frequency domain representation thereof, with the memory 20 being programmed accordingly.

The system 10 further can include an interface (or bus) 24 that enables a computer 26 to communicate with the modem system 14. The computer 26, for example, can correspond to a central control computer (e.g., a work station or a personal computer) in a central office of a service provider. The computer 26 can communicate via the interface 24 to a plurality of modems similar to the modem 14 to implement the desired testing for loop characteristics of a plurality of loops. The computer 26 can be local or remote relative to the modem system 14, such as located in a control station. A user can employ the computer 26 via the corresponding user interface 28, such as including a graphical and/or text-based human-machine interface. The user can also manually initiate the SELT algorithm via the user (e.g., human-machine) interface 28. Alternatively, the computer 26 can be programmed to initiate the SELT algorithm periodically or after certain events occur. The computer 26 can also be employed to control one or more aspects of SELT by providing instructions (e.g., network management functions, such as by using Operations Administration and Maintenance (OAM)) to the modem system 14 via the interface 24. The modem 14 can also provide the computer 26 with information describing the loop characteristics for the loop 12 based on the determination of loop characteristics, such as described herein. The computer 26 can in turn provide an indication of the loop characteristics to one or more output devices (e.g., a monitor, a printer and the like) indicated at 30.

FIG. 2 depicts an example of a loop testing system 50 that can be implemented according to an aspect of the present invention. The loop testing system 50 can be implemented as part of a DSL modem that is utilized to transmit and receive signals over an associated subscriber loop 52. For purposes of the example of FIG. 2, it will be assumed that the system 50 is implemented in an ADSL environment for transmitting data over a single POTS loop 52, although the system is applicable to other types and arrangements of communication systems.

The system 50 includes a DSP 54 that is programmed and configured to implement a single ended loop testing (SELT) algorithm. As part of the SELT algorithm, the DSP 54 is operative to control hardware as well as associated software for communicating test signals over the loop 52. In the example of FIG. 2, the corresponding hardware and software is indicated as the digital preprocessing/encoder block 56 and an inverse fast Fourier transform (IFFT) block 58. The DSP 54 thus provides input data to the digital preprocessing/encoder block 56 which, in turn, provides encoded data (e.g., corresponding to tones) to the IFFT block 58. The IFFT block 58 provides corresponding symbols as data samples in the time domain to an analog front end (AFE) 60. Those skilled in the art will understand that, for purposes of simplicity of explanation, various structural and functional features (e.g., including additional filtering and conversion) can be considered either incorporated into digital preprocessing/encoder block 56 or omitted from FIG. 2 since such features while typically form part of the modem system are not required for purposes of implementing SELT.

The loop 52 is coupled to the AFE 60 for propagating data to a subscriber's equipment associated with the loop. When data is transmitted over the loop 52 from the AFE 60, a response associated therewith can be returned to system 50 through the AFE 60. The AFE 60 provides the response to an averaging function 62 that is operative to obtain an average of the response to the sample signals transmitted by the IFFT 58 over the loop 52. For example, the averaging function 62 averages the responses over time for the same test signal transmitted multiple times. The average function 62 provides an average indication of the received signal to an FFT block 64. The FFT block 64 is operative to convert the time domain data from the average block 62 to a corresponding frequency domain representation. The frequency domain representation can be provided to additional hardware and software, which is represented in FIG. 2 as a digital processing decoder/equalizer block 66. The DSP 54 is coupled to communicate with and control the digital preprocessing decoder/equalizer block 66.

The FFT block 64 also provides the frequency domain representation to the DSP 54 for processing in accordance with an aspect of the present inventions. The DSP 54 includes a division function 70 that is operative to divide the frequency domain representation of the received signal by the frequency domain representation of the transmit signal to generate a corresponding echo frequency response 72. The echo frequency response 72 can be a complex echo response or it can be a magnitude echo response to reduce memory requirements. Those skilled in the art will understand and appreciate that the received signal can also be processed by the DSP 54 to ascertain characteristics or parameters associated with the loop 52. For example, the FFT block 64 can provide the frequency response for the receive signal directly to an analysis block 74, as indicated by the dashed line 76. As another alternative, some or all of the processing can be performed on a time domain representation of the response for the receive signal (e.g., provided to the analysis block 74 from the averaging function 62—not shown).

In the example of FIG. 2, the analysis block 74 employs the echo frequency response (e.g., an echo magnitude response) relative to data stored in a loop characteristic table 78 to ascertain an indication of the parameters associated with the loop 52. The loop characteristic table 78 is preprogrammed with echo response data for a plurality of loop configurations, each having known frequency characteristics. The echo response data stored in the loop characteristic table 78 can be in the frequency domain, or depending on the type of data that is to be provided to the analysis block 74 as part of the testing algorithm. Thus, in the example of FIG. 2, the response data stored in the loop characteristic table 78 corresponds to echo magnitude signal response data in the frequency domain.

To reduce data storage requirements associated with implementing the SELT algorithm in the DSP 54, the response data stored in the loop table 78 for each loop configuration can be stored as coefficients that represent the echo frequency responses determined for loops having known parameters. The loop characteristic table 78 can be programmed based on computer simulations performed on loop models. Additionally or alternatively, the loop characteristic table 78 can be programmed based on actual and empirical testing performed over a plurality of loops having differing characteristics as well as for a plurality of different AFEs for each loop configuration. By programming the table 78 testing over a plurality of AFEs, the response data stored in the loop characteristic table 78 can accommodate process variations associated with the AFEs and other chipset variations.

An interface 80 can be utilized to control and configure the SELT process, such as by a computer (or other input device) that is communicatively coupled to the DSP 54 via the interface 80. For instance, an operator at a central office can control the SELT algorithm implemented by the system 50 by entering instructions through the interface 80. As a further example, the interface 80 can be utilized to input a priori information for one or more known parameters of the loop 52 that is being tested. Based on such a priori information, for example, the analysis block 74 can reduce the table 78 to a subset of the entries in the table 78 that include the a priori information provided to the interface 80. Additionally, an operator or other user can send an appropriate start command to the DSP to initiate SELT through the interface 80. The system 50 can also provide the results of SELT performed by the analysis block 74 over the interface 80, including an identification of one or more loop characteristics for the loop 52 based on the results of the analysis between the received echo response 72 and the stored loop characteristic and response data in the table 78, such as described herein.

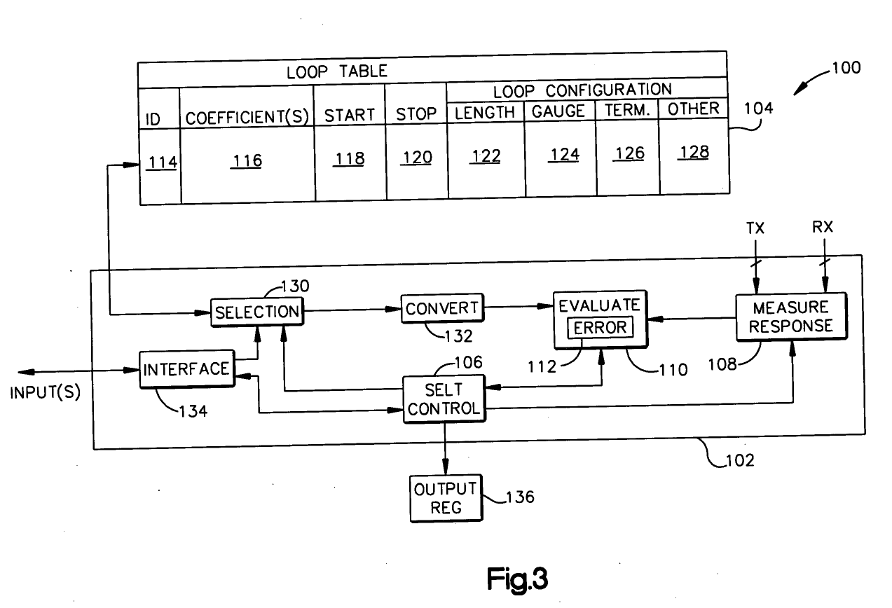

FIG. 3 depicts another example of a system 100 that can be utilized to determine loop characteristics according to an aspect of the present invention. The system 100 includes a SELT algorithm 102 that is operative to perform the determination of the loop characteristics. The SELT algorithm 102 can be implemented as software instructions that are executable by processor (e.g., a DSP) as hardware or as a combination of hardware and software. The SELT algorithm 102 ascertains the loop characteristics based on predetermined data stored in a loop table 104 (e.g., ROM, EPROM, RAM, FLASH, and the like).

The SELT algorithm 102 includes a SELT control block 106 that is operative to control the SELT algorithm 102. The SELT control block 106 includes a measurement block 108 that is operative to ascertain an indication of a receive signal response for an associated loop (not shown). The measurement block 108 can determine the receive signal response based on a receive signal (RX) or based on a transmit signal (TX) and the RX signal. The measurement block 108 can provide the receive signal response data to an evaluate component 110. The response data can be provided in the time domain or the frequency domain. For purposes of simplicity of explanation and consistency, the SELT algorithm 102 will be described in FIG. 3 with respect to a frequency response or, more specifically an echo frequency response in the frequency domain, which can be measured by dividing the RX signal by the TX signal.

The evaluate block 110 is operative to evaluate the signal response based upon predetermined response characteristics stored in the loop table 104. The evaluate block 110 is programmed and/or configured to include an error function 112 that is operative to determine an error value (e.g., a mean squared error) between the measured echo frequency response and a response based on corresponding echo response data stored in the loop table 104.

In the example of FIG. 3, the loop table 104 includes a plurality of entries that can be utilized to provide an indication of a response for each of a plurality of loop configurations for use by the evaluate block 110. The table 104 thus can store the loop configuration data as a linear array of elements. For example, the loop table 104 can include an entry (ID) 114 that operates as an index into the loop table 104. The ID entry 114 can be associated with each entry to enable accessing response data and other data associated with a given ID entry.

The loop table 104 can also include a coefficient entry 116. The coefficient entry 116 corresponds to coefficients of a polynomial expression which has been determined to approximate an echo frequency loop configuration. Start and stop entries 118 and 120, respectively, are associated with each set of coefficients to identify a tone range over which the coefficients 116 apply in the polynomial to provide the echo frequency response. Associated with each ID entry 114 are also loop configuration data. The loop configuration data can include a loop length field 122, a gauge field 124, termination type field 126 as well as one or more other SELT parameter fields, indicated at 128. Each of the loop configuration fields 122, 124, 126 and 128 collectively corresponds to a loop configuration for each indexed entry 114 and is associated with a set of coefficients 116 that define a corresponding signal response.

The SELT control block 116 controls a selection component 130 to obtain coefficients 116 and start and stop data 118 and 120, respectively, for a given indexed entry in the loop table 104. The selection component 130 provides the coefficients and start/stop information 116, 118 and 120 to a conversion block 132 that converts the coefficients to a corresponding polynomial curve corresponding to an echo frequency response (e.g., an echo magnitude frequency response) for the tone range defined by the start and stop tones 118 and 120.

For each selected entry, the conversion block 132 provides a corresponding signal response within the start and stop tone range to the evaluate block 110. The error function 112 thus computes the corresponding error between the measured response provided by the measurement block 108 and the converted response for a given entry of the loop table 104 to determine a corresponding error value. The error function 112 determines which entry has a minimum error value and then provides the entry ID information to the SELT control block 106. The selection component 130 can in turn access the loop table 104 and obtain corresponding loop configuration data 122, 124, 126 and 128 and provide such information to a corresponding memory 136, such as a predefined output register. Alternatively, the SELT control block 106 can provide the resulting loop configuration data 122, 124, 126 and 128 through the interface 134 to an associated device, such as a control console or a computer in a central office.

If one or more of the loop characteristics, such as loop gauge or termination type, are known, a user can enter such information as a priori information into the SELT algorithm 102 to facilitate analysis via the interface 134. The selection component 130 can employ this a priori information to implement a table mask to exclude certain indexed entries 114 from the SELT algorithm 102. The interface 134, for example, can receive input data from an associated computer or user entry device that defines certain known loop configuration characteristics or other a priori information associated with the loop being tested. The SELT control block 106 can employ the a priori information to cause the selection component 130 to exclude from consideration entries in the loop table 104 that do not include the known types of data. For instance, where a given loop is known to have a particular gauge wire, all loop table entries that have different gauges can be excluded from the SELT algorithm 102, thereby greatly simplifying the algorithm as well as improving accuracy. Those skilled in the art will understand and appreciate that any type of a priori information about the loop characteristic can be utilized to generate an appropriate mask by the selection block 160.

The a priori loop configuration should be entered by a user prior to initiating the SELT algorithm 102. For instance, a user can enter information to identify a known loop gauge, a known loop termination as well as whether the SELT algorithm is to be implemented with or without calibration. If no a priori loop configuration information is entered, the SELT algorithm can be performed against all possible loop configurations, including loop gauges and terminations in the table 104. As an example, the input information, including a priori loop configuration information, can be provided via the interface 134 as a six byte entry having a format as set forth in the following Table 1.

TABLE 1

| Byte # | Parameter | Table Entry Value |
|---|---|---|
| Byte 0 | Command Type = 6 for SELT | 6 (fixed) |
| | Test | |
| Byte 1 | Subtype = 2 Simple SELT | 2 (fixed) |
| | Hypothesis Configuration | |
| Byte 2 | Termination Type | Bit mapped termination |
| | | type |
| Byte 3-4 | Gauge Type | Bit mapped gauge type |
| Byte 5 | Calibrated/Non Calibrated | 0(fixed) |

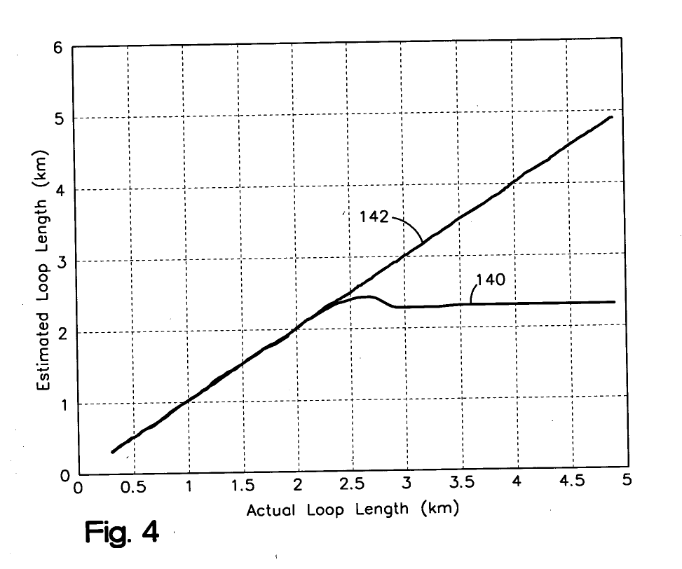

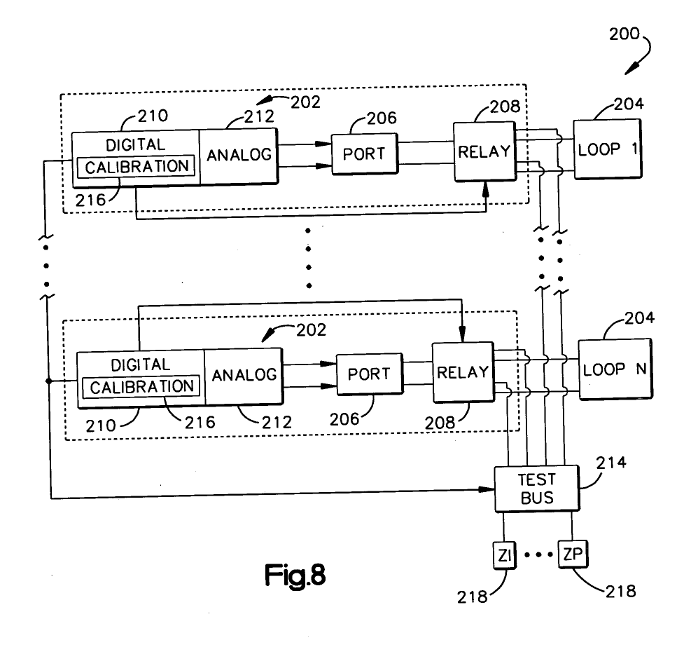

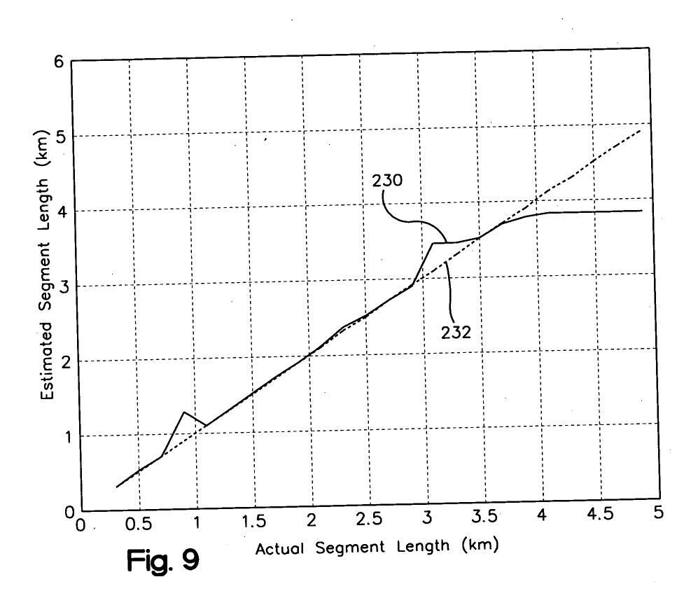

FIG. 4 depicts an example of a loop length estimate that can be obtained by employing SELT according to an aspect of the present invention, such as by the system 100 of FIG. 3. In-FIG. 4, an estimated loop length 140 is plotted versus the actual loop length for various lengths of a 0.5 mm gauge wire. For purposes of the example depicted in FIG. 4, it is assumed that the loop includes a known termination impedance of 10 K and no calibration is performed. A corresponding plot of actual loop length 142 is shown for purposes of comparison. From FIG. 4 is shown that the SELT performs reasonably well for the given loop configuration up to a loop length of approximately 2.7 kilometers. As shown and described herein (see, e.g., FIGS. 8 and 9), further improvements can be achieved by employing calibration with SELT.

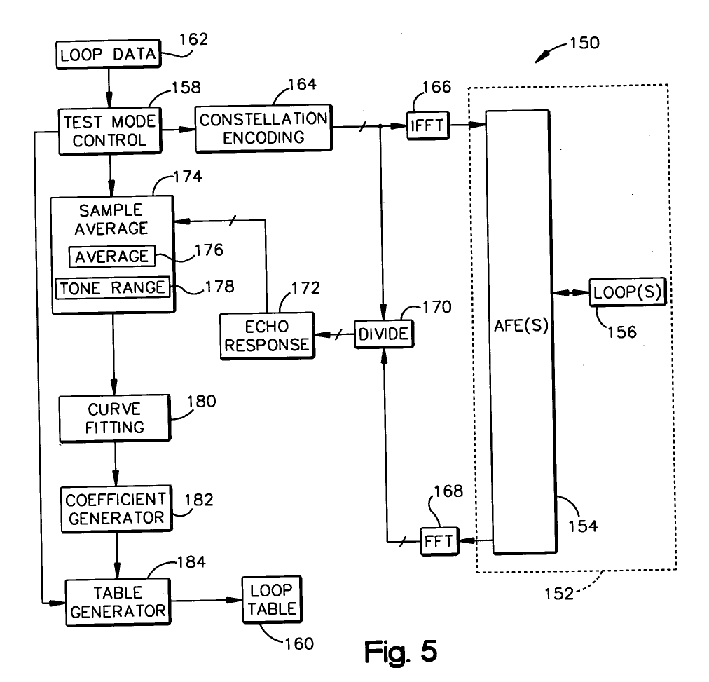

FIG. 5 illustrates an example of a system 150 that can be utilized to generate a loop table 160 for use in determining loop characteristics, such as described herein. It is to be understood and appreciated that a corresponding loop table 160 can be generated based on performing computer simulations on a subscriber loop 156 for a plurality of different loop configurations, based on performing empirical testing for a plurality of different loop configurations or based on a combination of computer simulations and empirical testing. Additionally, by performing sample testing for a plurality of analog front ends 154, the resulting loop table 160 can be generated to accommodate for process variations associated with fabrication of the AFEs and components variations used in the AFEs.

The loop table generation system 150 also includes a test mode control 158 that is operative to control the process of obtaining and processing data for use in generating the corresponding table 160. The test mode control 158 is loaded with loop data 162 corresponding to known characteristics associated with the loop 156. The loop data 162, for example, can include the length of the loop 156, the gauge of the wire for the loop, the type of loop termination as well as other characteristics, including whether calibration is to be implemented. Those skilled in the art will understand and appreciate that the loop table 160 can be programmed and generated to include a variety of loop parameters data that can be employed to characterize an associated loop 156.

The test mode control 158 provides a test signal (e.g., a REVERB signal) to a constellation encoding block 164. The constellation encoding block 164 encodes the test signal as data on appropriate carriers and subcarriers and provides the encoded data to an IFFT block 166. The IFFT block 166 in turn provides a corresponding time domain signal to the analog front end 154. The analog front end 154 in turn transmits a corresponding analog signal over the loop 156. Signals are received by the AFE 154 and are provided to a FFT block 168. The FFT block 168 converts the received time domain signal to a frequency domain representation thereof, which is provided to a divide component 170. Averaging can also be performed so that the frequency domain signal includes an average symbol response over a plurality of samples. The divide component 170 divides the transmitted frequency domain signal by the received frequency domain signal provided by the FFT component 168 to generate a corresponding echo frequency response. By performing the division, the divide block 170 is capable for providing a corresponding echo response associated with the AFE 154 and loop 156 based on the transmitted signal. Those skilled in the art will understand and appreciate that alternatively, a time domain signal could be utilized to generate the corresponding table. Alternatively, the measured signal response received from the loop (in a time domain or a frequency domain) can be utilized to generate the table 160 in the absence of generating an echo response from the transmitted signal.

The sample component 172 stores a block of samples for each symbol in the echo response 172. As an example, the sample block 172 can collect data for about 4,000 (e.g., 4096) symbols over a plurality of samples (e.g., 128 samples). The sample block 172 can include an averaging function 176 that sums the symbols for each of the respective samples and obtains an average symbol value for each of the plurality of samples. The sample component 174 can also include a tone range component 178 that is operative to define a relevant tone range for the respective average sample that was obtained. The tone range component 178 determines the relevant tone range to reduce storage requirements for generating the respective table 160. For example, the tone range can be selected for a range of tones in the signal response that maximizes the distinguishing characteristics for each loop configuration. Those skilled in the art will understand and appreciate that the particular tone ranges can be determined for a given loop configuration based on experimentation or experience of the designer.

The sample system 174 provides an average sample echo response over a corresponding tone range (e.g., start and stop tones determined by the tone range component 178) to a curve fitting function 180. The curve fitting function 180, for example, can include polynomial fitting for an averaged frequency response data over the selected tone range to a corresponding polynomial. The order of the polynomial should be selected to distinguish adequately between signal responses for different loop characteristics. Different orders of polynomials further can also be employed for different loop configurations. As an example, a fourth order or fifth order polynomial can be used to approximate the signal response over a given tone range for most existing loop configurations, although a higher order polynomial can be employed for improved accuracy.

The curve fitting function 180 provides an indication of the respective polynomial approximation to a coefficient generator 182. The coefficient generator 182 is operative to extract corresponding coefficients for the polynomial defined by the curve fitting function 180. The coefficient generator 182 in turn provides the respective coefficients for the polynomial that approximates the echo response provided by the sampling function 174 to a table generator 184. The table generator 184 in turn generates the corresponding loop table 160 by populating the table with the known a priori loop data provided at 162, with the coefficients generated by the coefficient generator 182 as well as an indication of the start and stop tones for the tone range over which the polynomial represents the signal response. The test mode control 158 further can identify whether calibration was implemented in conjunction with obtaining the signal response and configuration data for a given entry in the loop table 160.

By way of further example, a data structure can be defined to store entries for the loop table 160. The polynomial coefficients can be stored as an integer entry having a predetermined number of bits (e.g., 32 bits). The start and stop tone entries can be defined by a byte or other number of bits to identify a respective tone in the available signal spectrum (e.g., 64 tones) in which data is transmitted. The type of data can vary depending on the type of response data being obtained for a given loop configuration. The loop length information can be stored in each table entry as a 16 bit integer value, which can be stored in corresponding units, such as feet or meters. A 16 bit value can be used to store the loop gauge information in the entry, such as can be bit mapped as in the table below. One or more bits (e.g., bits 8-15) can be used to define user-defined gauge types.

TABLE 2

| Bit No | Gauge Type |
|---|---|
| 0 | AWG_22 |
| 1 | AWG_24 |
| 2 | AWG_26 |
| 3 | PE_032MM |
| 4 | PE_04MM |
| 5 | PE_05MM |
| 6 | PE_063MM |
| 7 | PE_09MM |
| 8-15 | User Defined |

A loop termination field can be represented as a byte, such that different terminations are mapped as set forth below in TABLE 3.

TABLE 3

| Bit No | Gauge Type |
|---|---|
| 0 | Open |
| 1 | Short |
| 2 | 100 Ohm |
| 3-7 | Unknown/User defined |

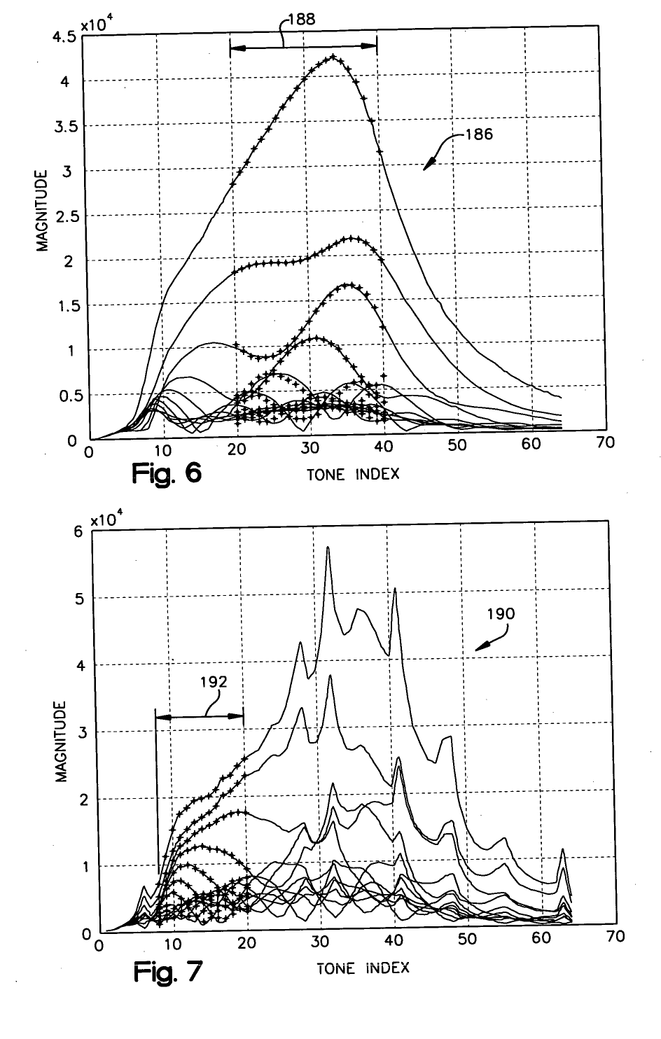

FIGS. 6 and 7 depict echo magnitude responses 186 for different loop configurations that can be utilized to generate corresponding loop data according to an aspect of the present invention. In FIG. 6, echo magnitude responses 186 with polynomial fit are shown for a straight loop having a 0.4 mm gauge and termination of 10 K. The echo magnitude responses 186 are shown for all 64 tones in the DMT (Discrete Multi-Tone) spectrum. The solid lines depicted in FIG. 6 correspond to the echo responses for all 64 tones of the spectrum. The portions of the curves represented by asterisks indicate the corresponding polynomial fit performed relative to the signal response data over a corresponding tone range indicated at 188. In FIG. 6, the polynomial fit is performed over the tone range 188 from about tone 20 to about tone 40. By utilizing a fourth order polynomial, five polynomial coefficients are generated for each of the 64 curves within the tone range 188.

FIG. 7 depicts signal responses 190 for 64 tones corresponding to a loop configuration that includes a straight loop having a 0.5 mm gauge and a 10 K termination. In the example of FIG. 7, a polynomial fit is performed over a tone range 192, which extends from about tone 7 to about tone 20 as indicated by asterisks for the respective tones.

FIG. 8 depicts an example of a system 200 that can employ SELT with calibration. The system in FIG. 8 is depicted as including a plurality of modem systems 202 that are coupled to respective subscriber loops (LOOP 1 through LOOP N, where N is a positive integer) 204 through corresponding ports 206 and relays 208. The modem systems 202 can correspond to one DSL line card or multiple modems can be spread across a plurality of line cards. The modem systems 202, for example, may reside at a central office of a PSTN (Public Switched Telephone Network). It will be appreciated, however, that the system 200 could be implemented with any number of one or more modems associated with one or more respective single loops. The modems 202 are schematically illustrated as including a digital portion 210 and an analog portion 212. The digital portion can include a DSP and other digital circuitry and memory for processing and encoding/decoding data that is communicated via the analog portion over the associated loop 204. While a separate modem system 202 is depicted with each port 206, it will be appreciated that much of the circuitry of the modem system can be configured to transceive signals via a plurality of the ports 206.

During normal operation (e.g., a normal operating mode), the relays 208 are configured to couple each port 206 to its associated loop 204. As used herein, the relay 208 can include any switching or routing system capable of altering the path of a signal being communicated relative to a respective modem system 202. During a calibration mode for a given modem 202, the associated relay 208 couples a respective port 206 with an associated test bus 214. The digital portion 210 or other entity (e.g., the SELT algorithm) of the modem system 202 can control the relay 208 to provide a desired communications path for the modem, which path can vary based on the operating mode of the modem system. While a single test bus 214 is depicted in FIG. 8, there can be any number of test buses for use in implementing calibration.

The digital portion 210 includes a calibration function 216 that can be employed for calibrating an associated SELT algorithm also implemented by the digital portion, such as according to any of the approaches described herein (see, e.g., FIGS. 1, 2, 3 or 11). The calibration function 216, for example, can include computer-executable instructions that are executed by an associated processor to calibrate the modem to mitigate the effects of process variations for components in the modem, including the analog portion 212 and external components and couplings associated with the loop 204. According to one aspect of the present invention, the calibration function 216 can employ an S-parameter calibration scheme while the modem system 202 is coupled to the test bus 214.

By way of example, S-parameter calibration can correspond to the types of calibration that is commonly used in network analyzers where a probe (or circuit) is used to connect to the device under test (DUT). For instance, during calibration the relay 208 operates to remove the loop 204 and couple the port 206 with one or more known test loads 218, indicated at Z1 through ZP, where P is a positive integer denoting the number of test loads being employed during calibration. In one implementation, the modem system 202 can control the test bus 214 of the calibration process to sequentially couple the port 206 with a selected one of the test loads 218 during different phases of calibration. For example, the test bus 218 can be implemented as including a relay or other switching system operative to selectively couple one (or more) of the test loads 218 with the relay 208. For purpose of S-parameter calibration, the DUT corresponds to the loop 204 and the probe corresponds to the analog portion 212 of the modem system. The test loads 218, for example, can include a short circuit path (e.g., 0 Ohm or other low resistance), an open circuit path, and a 100 Ohm load or other test loads representative of normal operating conditions. The modem system 202 takes measurements with each of these loads, such as based on transmitting a REVERB signal and then uses the results to determine the two-port S-parameters (e.g., S11, S12, S21 and S22) of the analog portion 212. Thus, when the associated loop 204 is reconnected, the modem system 202 can accurately ascertain only the properties of the loop 204 since the properties of the analog portion 212, having been determined during the calibration process, can be effectively removed from the measurement data.

In practice, the calibration function 216 can operate to disconnect the loop and computing the echo response sequentially for “open”, “short” and “100 ohm” (or other “normal”) test load conditions associated with the phases of calibration. Referring to these three measurements as S₁₁, S₁₁⁰ and S₁₁^{L} respectively, the S-parameters for the analog portion 212 can be computed as follows:

$$\begin{matrix}{S}_{11}^{A} = {S}_{11}^{L} , {S}_{22}^{A} = \frac{2 {S}_{11}^{L} - {S}_{11}^{∞} - {S}_{11}^{0}}{{S}_{11}^{0} - {S}_{11}^{∞}} , and & Eq . 1 \\ {S}_{12}^{A} {S}_{21}^{A} = \frac{2 ( {S}_{11}^{∞} - {S}_{11}^{L} ) ( {S}_{11}^{0} - {S}_{11}^{L} )}{{S}_{11}^{0} - {S}_{11}^{∞}} . & Eq . 2\end{matrix}$$

If the echo response measurement with the actual loop attached is S₁₁^{M}, then S₁₁ for the loop itself can be computed as follows:

$${S}_{11} = \frac{{S}_{11}^{A} - {S}_{11}^{M}}{{S}_{22}^{A} ( {S}_{11}^{A} - {S}_{11}^{M} ) - {S}_{12}^{A} {S}_{21}^{A}} . \qquad Eq . 3$$

S₁₁ rather than the raw echo response can then used by the analysis system of a loop testing system to estimate loop parameters during implementation of SELT. When using calibration measurements, the computed response is computed as S₁₁ according to computed calibration measurements. The calibration can be performed just prior to implementing SELT to help ensure that accurate conditions exist for the calibration as compared to normal operation when the loop 204 is connected. If calibration is employed during SELT, the response table should also be programmed by employing calibration.

FIG. 9 depicts an example of a loop length estimate that can be obtained employing SELT with calibration according to an aspect of the present invention. In FIG. 9, an estimated loop length 230 is plotted versus the actual loop length 232 for various lengths for various lengths of a 0.4 mm gauge wire. For purposes of the example depicted in FIG. 9, it is assumed that the loop includes a known termination impedance of 10 K and calibration is performed. The plot of actual loop length 232 is shown for purposes of comparison. From FIG. 9, it is shown that the simulation performs reasonably well up to nearly four kilometers. Thus, by way of comparison with the example of FIG. 4, where no calibration was performed, the SELT algorithm with calibration can enable an accurate determination of loop length over a larger range of loop lengths.

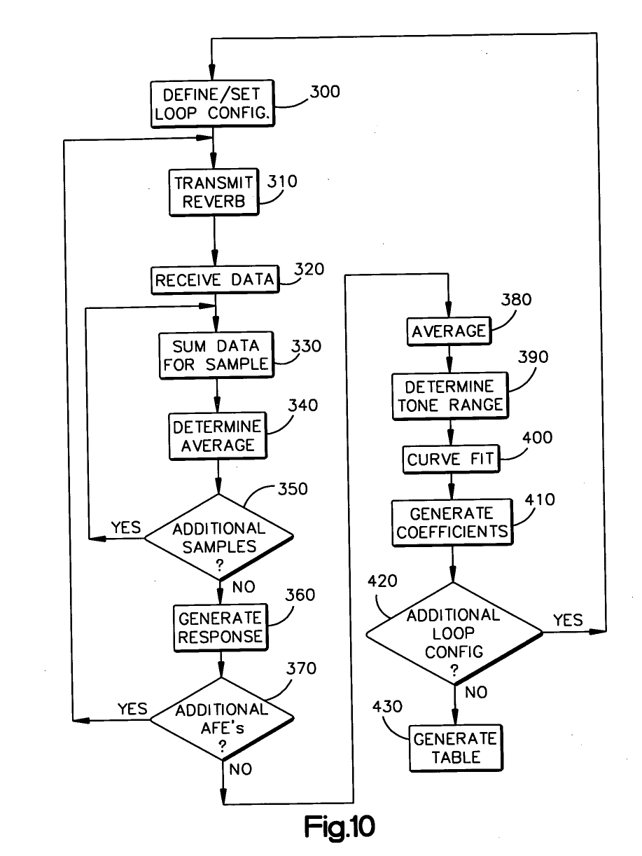

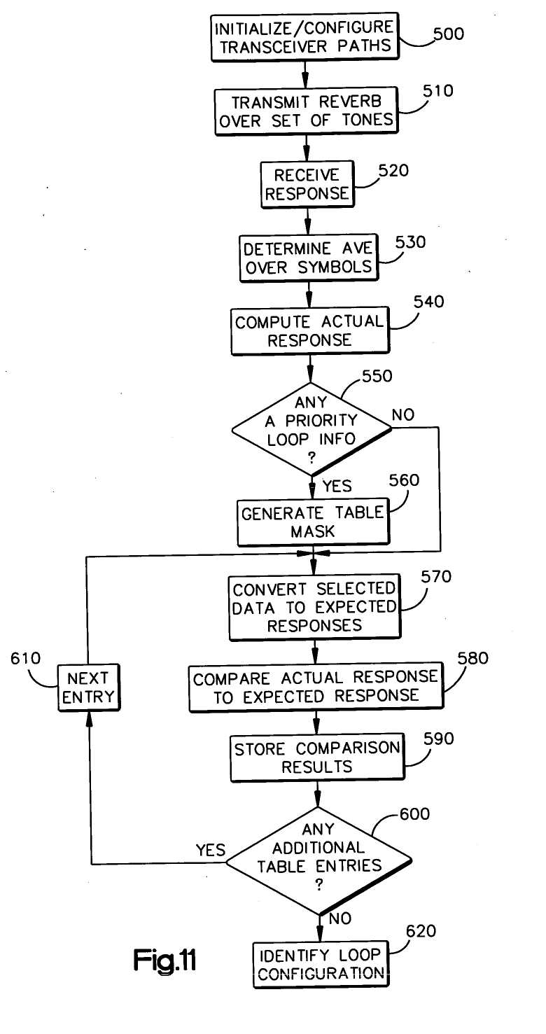

FIGS. 10 and 11 depict methods that can be performed in connection with determining loop characteristics associated with automatic gain control for a multi-stage system according to an aspect of the present invention. While, for purposes of simplicity of explanation, the methodologies are shown and described as executing serially, it is to be understood and appreciated that the present invention is not limited by the orders shown, as some aspects may, in accordance with the present invention, occur in different orders or concurrently from that shown and described herein. Moreover, not all features shown or described may be needed to implement a method in accordance with the present invention. Additionally, such methods can be implemented in hardware (e.g., analog circuitry, digital circuitry or a combination thereof), software (e.g., running on a DSP or ASIC) or a combination of hardware and software. Those skilled in the art will understand how to program appropriate components (e.g., a DSP implemented in a DSL modem) to implement the methods based on the teachings contained herein.

FIG. 10 depicts a flow diagram for an example method that can be employed to generate a table for use in performing SELT according to an aspect of the present invention. The method begins at 300 in which a given loop configuration is defined. The loop configuration can be defined by identifying one or more known loop characteristics for the given loop, such as loop length, termination type, and loop gauge to name a few. At 310, a REVERB signal is transmitted. The REVERB signal is transmitted over the loop that was defined at 300, such that a response is received at 310. The data for the response is summed for the respective sample at 330. At 340, an average is determined for the sample, such as by dividing the summed data over the number of symbols that form the data in the sample. At 350, a determination is made as to whether any additional samples exist. If additional samples exist, the method returns from 350 to 330 to repeat the summation and averaging for the next one or more samples. For example, a sufficient sample size can include about 128 samples, each sample containing about 4096 symbols, although other sample sizes and constellation sizes can be employed.

At 360, a response is generated based on the samples for the received signals. The response can correspond to an echo magnitude response of the received signals according to the averaging performed relative to the samples of symbols that were aggregated at 340. The echo response can be generated by dividing out the transmitted portion of the reverb signal that was sent over the loop configuration under test at 310.

At 390, a tone range is determined. The tone range can include a start tone and a stop tone for the averaged response generated at 380. The tone range can differ for each loop configuration for which a table entry is being generated so that the portion of the frequency response can facilitate distinguishing between responses of other loop configurations. Additionally, by selecting a portion of the frequency response within the tone range, memory requirements for storing a representation of the echo response can be reduced.

At 400, curve fitting is performed relative to the portion of the echo response defined by the tone range determined at 390. The curve fitting, for example, can correspond to a polynomial fit, such as can be performed by any curve fitting tool (e.g., the curve fitting toolbox in MATLAB® software from Mathworks, Inc. or other commercially available or proprietary tool). At 410, coefficients can be generated based on the curve fitting at 400. For instance, where a fourth order polynomial is determined to fit the frequency response for the given tone range, five corresponding coefficients will typically be generated at 400. Those skilled in the art will appreciate that any suitable order polynomial can be used to describe the frequency response, and that different order functions can exist for different responses.

At 370, a determination is made whether any additional AFEs exist for which corresponding responses are to be generated. As described herein, responses can be generated for a plurality of different AFEs so that component and performance variations across a sufficient sample of hardware can be considered. In this way, the response data can be better approximate a range of AFEs that might be encountered in modem systems employing SELT. If additional AFEs do exist (YES), the method returns to 300 to repeat the foregoing process for each respective AFE. At 400, after corresponding responses and coefficients have been generated for each of the AFEs (NO), the method can proceed to 380. At 380, an averaging is performed for the respective responses generated at 360 for each AFE to provide an average indication of the frequency response over a plurality of AFEs. As an alternative to averaging responses, it will be appreciated that other representations can be averaged or other functions performed to describe signal responses for the plurality of AFEs and the given loop configuration.

At 420, a determination is made as to whether any additional loop configurations exist for which data is to be generated for populating a table. If additional loop configurations do exist at 420 (YES), the method returns to 300 to repeat the method for the next loop configuration. After corresponding data has been generated for each of the loop configurations (NO), the method proceeds from 420 to 430. At 430, a corresponding table is generated. The table can include a set of coefficients that define a received signal response (e.g., an echo magnitude response in the frequency domain) for a given loop configuration over a defined tone range. The table can also include the known characteristics associated with the response for each loop configuration. Those skilled in the art will understand and appreciate various types of data structures (e.g., linear array of elements, linked list, records, etc.) that can be employed to store the data for use in implementing SELT.

FIG. 11 depicts an example of a method that can be employed to implement SELT according to an aspect of the present invention. The method begins at 500 in which one or more transceiver paths are initialized and/or configured. For example, a path can include digital and analog circuitry of an associate DSL modem that is coupled to communicate over a subscriber loop, such as a POTS line. The initialization can occur in response to a command from an operator, such as may be entered at a control console or computer located at a central office of a DSL provider.

At 510, a REVERB signal is transmitted over a set of tones. The set of tones can include a set of frequencies that overlap between the transmit and receive paths of the DSL system. At 520, a response to the transmitted signal is received. An average of the response is determined at 530 over a set of symbols (e.g., about 4000 symbols), such as for symbols in each of a plurality of samples. At 540, an actual response is computed. The actual response can be computed in the time domain or the frequency domain. For example, an echo magnitude response can be computed in the frequency domain by dividing out the transmitted portion of the signal from the response received at 520.

At 550, a determination is made as to whether any a priori information has been entered for the loop being tested (e.g., entered at 500 in connection with instructions to initiate SELT). For example, the a priori information can include one or more characteristics known about the loop being tested, such as gauge of line, termination type and the like. If a priori information has been entered (YES), the method proceeds to 560 in which a table mask is generated based on the a priori information. The table mask is employed to exclude entries from the table that do not comport with the a priori information. Thus, only those entries that match the characteristics entered as a priori information need to be utilized for subsequent analysis. If no a priori information has been entered for the loop (NO), the method proceeds from 550 to 570 without generating a mask, such that all entries are considered during subsequent analysis. Also, from 560, the method proceeds to 570.

At 570, selected data for a given entry in the table is converted to an expected response, such as a corresponding echo frequency response for a known loop configuration. The selected data can correspond to a set of coefficients that define a polynomial over a range of tones associated with the loop configuration for which the expected response was generated. At 580, the actual response generated at 540 is compared to the expected response from the table. The comparison, for example, can include a mean square error or other minimization function operative to ascertain an indication of the difference between the actual response and the expected response. At 590, the results of the comparison (at 580) are stored, such as can include an error value. Thus, the response that provides the minimum error value (or at least means for accessing loop configuration data associated with such response) can be stored at 580. Alternatively, all results and an identification of the expected response for a respective loop configuration can be stored at 580.

At 600, a determination is made as to whether any additional entries exist in the table for evaluation relative to the actual response. If additional entries do exist (YES), the proceeds to 610 to access the next entry in the table, and the method returns to 570 to evaluate and compare the expected response for this next entry. It will be appreciated that if a priori information was entered, one or more entries can be removed from consideration so that the method can implement more quickly. The accuracy of the SELT can also be improved, as there will be a reduced likelihood of false positive results if some of the entries are removed from consideration. If no additional entries exist at 600 (NO), the method proceeds from 600 to 620 in which a loop configuration for the loop being tested is identified. The identification, for example, can be made based on the results stored at 590, such as corresponding to the loop configuration that provides a minimum error.

What have been described above are examples of the present invention. It is, of course, not possible to describe every conceivable combination of components or methodologies for purposes of describing the present invention, but one of ordinary skill in the art will recognize that many further combinations and permutations of the present invention are possible. For example, while the systems and methods herein have generally been described in the context of modems for digital subscriber lines, the systems and methods can be applied to various other types of wired communication systems where line testing may be desired. Accordingly, the present invention is intended to embrace all such alterations, modifications, and variations that fall within the spirit and scope of the appended claims.

What is claimed is:

1. A system to determine at least one characteristic associated with a subscriber loop, comprising:
memory that stores data indicative of signal responses and loop characteristics for a plurality of loop configurations; and
a processor programmed to ascertain at least one loop characteristic associated with the subscriber loop based on evaluation of data associated with a signal response received via the subscriber loop relative to at least a portion of the data indicative of signal responses stored in the memory.

2. The system of claim 1, wherein the stored data further comprises coefficients that represent at least a portion of a signal response associated with each of the plurality of loop configurations.

3. The system of claim 2, wherein the coefficients correspond to coefficients of a polynomial approximation for each of a plurality of the signal responses for the plurality of subscriber loop configurations.

4. The system of claim 3, wherein the stored data further comprises data that defines a frequency range for the polynomial approximation for each of the plurality of the signal responses for the plurality of loop configurations.

5. The system of claim 2, further comprising a converter that converts the coefficients associated with a given loop configuration to a corresponding signal response representation, the processor ascertaining the at least one loop characteristic based on analysis of the signal response representation relative to a response computed based on the signal response received via the subscriber loop.

6. The system of claim 1, wherein the at least one loop characteristic further comprises at least one of loop length, gauge, and termination type of the subscriber loop.

7. The system of claim 1, wherein the processor determines the at least one loop characteristic according to which of the plurality of loop configurations provides a minimum difference between the signal response received via the subscriber loop and frequency responses corresponding to the data stored in the memory for the plurality of loop configurations.

8. The system of claim 1, wherein the processor determines the at least one loop characteristic based on an echo frequency response that is computed based on the signal response received via the subscriber loop in response to at least one test signal transmitted to the subscriber loop.

9. The system of claim 8, wherein the processor employs the echo response in one of the frequency domain and the time domain, according to which type of data is stored in the memory as the data indicative of signal responses for the plurality of loop configurations.

10. The system of claim 1, further comprising an interface operative to input at least one a priori information associated with the subscriber loop, the processor employing the a priori information to select which of the plurality of loop configurations are employed to determine the at least one loop characteristic.

11. The system of claim 1, further comprising a calibration function operative to enable the processor to account for and to mitigate process variations associated with at least analog portions of a transmit and receive path communicatively coupled with the subscriber loop.

12. The system of claim 1, wherein the memory further comprises a data structure that includes at least one response field for storing coefficients that represent the data indicative of a signal response for each of the plurality of loop configurations, and at least one field, which is associated with the at least one response field, for storing at least one predetermined loop characteristics for each of the plurality of loop configurations.

13. The system of claim 2, wherein the stored data further comprises data indicative of signal responses that represents an average indication of signal responses for a plurality of analog front ends associated with each of the plurality of loop configurations.

14. A system to determine at least one characteristic of a communications medium, the system comprising:
a measurement component that determines an indication of a response received from the communications medium in response to a test signal transmitted over the communications medium;
a data structure that includes signal response data for a signal response associated with each of a plurality of known configurations of the communications medium, the data structure including at least one characteristic associated with each of the plurality of known configurations of the communications medium; and
an evaluator that evaluates the indication of the response received from the communications medium relative to the signal response data of the data structure to determine the at least one characteristic of the communications medium.

15. The system of claim 14, wherein the data structure comprises a preprogrammed table.

16. The system of claim 14, wherein the signal response data associated with each of the plurality of known configurations of the communications medium further comprises coefficients generated to define at least a portion of a signal response for each of the plurality of known configurations of the communications medium.

17. The system of claim 16, further comprising a converter that converts coefficients for a selected one of the plurality of known configurations to a corresponding signal response, the evaluator determining the at least one characteristic of the communications medium based on the corresponding signal response relative to the indication of the response received from the communications medium.

18. The system of claim 17, further comprising a selector that accesses the data structure to provide the selected one of the plurality of known configurations to the converter.

19. The system of claim 18, further comprising an interface operative to input a priori information associated with the communications medium, the selector masking out the plurality of known configurations based on the a priori information to facilitate the determination of the at least one characteristic of the communications medium.

20. The system of claim 14, wherein the at least one characteristic further comprises at least one of loop length, gauge, and termination type of the communications medium.

21. The system of claim 14, wherein the communications medium comprises a subscriber loop of a digital subscriber loop system.

22. The system of claim 20, wherein the signal response data associated with each of the plurality of known configurations of the communications medium represents an average indication of responses for a plurality of analog front ends associated with each respective one of the plurality of known configurations.

23. The system of claim 14, wherein the measurement component provides the indication of the response received from the communications medium as an echo frequency response computed based on the response received from the communications medium.

24. The system of claim 14, further comprising a calibration function operative to adjust the indication of the response received from the communications medium to mitigate process variations associated with at least analog portions of a transmit and receive path communicatively coupled with the subscriber loop.

25. The system of claim 14, further comprising a digital signal processor, the measurement component and the evaluator comprising computer executable instructions executed by the digital signal processor.

26. A system to determine at least one characteristic associated with a subscriber loop, comprising:
means for providing an indication of a signal response during a test mode in response to a test signal transmitted over the subscriber loop; and
means for identifying the at least one loop characteristic based on comparing the indication of the signal response relative to a plurality of expected responses associated with known loop configurations.

27. The system of claim 26, further comprising means for storing corresponding coefficients that represent each of the plurality of expected responses associated with known loop configurations.

28. The system of claim 27, further comprising:
means for converting the coefficients for at least some of the known loop configurations into corresponding responses; and
means for evaluating the corresponding responses relative to the indication of the signal response to determine the at least one loop characteristic for the subscriber loop.

29. A method comprising:
transmitting at least one test signal over a subscriber loop;
receiving a signal response to the at least one test signal;
determining an actual response associated with the subscriber loop based on the received signal response;
comparing the actual response relative to stored response data for at least one expected response for at least one predetermined loop configuration; and
identifying at least one characteristic of the subscriber loop based on the comparison.

30. The method of claim 29, further comprising determining an average response for symbols in each of a plurality of samples of the received signal response, the actual response being determined based on the average response.

31. The method of claim 29, further comprising generating a mask based on a priori information for the subscriber loop that is received prior to initiating the transmission of the test signal.

32. The method of claim 29, wherein the actual response for the subscriber loop comprises an echo frequency response.

33. The method of claim 29, wherein the stored response data further comprises stored response data generated as an average indication of responses for a plurality of analog front ends associated with each of a plurality of predetermined loop configurations.

34. A digital signal processor programmed to perform the method of claim 29.
